(19) United States
(12) Patent Application Publication
(10) Pub. No.: US 2006/0240873 A1
(43) Pub. Date: Oct. 26, 2006

(54) Method for displaying images in telecommunication terminal and telecommunication terminal using the same

(75) Inventors: Jeong-Min You, Suwon-si (KR); Jong-Min Lee, Seoul (KR); Youn-Hee Cho, Bucheon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/174,818

(22) Filed: Jul. 5, 2005

(30) Foreign Application Priority Data
Apr. 22, 2005 (KR) 33788/2005

(51) Int. Cl. H04B 1/38; H04M 1/00

(52) U.S. Cl. 455/566; 455/556.1

(57) ABSTRACT

Disclosed is an apparatus and a method for displaying images or videos in a telecommunication terminal having a rotatable display. When the display has been rotated, images or videos are displayed as they are and, when the display has not been rotated, target regions are chosen from the images or videos based on the screen size and are displayed.

### PRIORITY

This application claims priority to an application entitled “Method for Displaying Images in Telecommunication Terminal and Telecommunication Terminal Using the Same” filed with the Korean Intellectual Property Office on Apr. 22, 2005 and assigned Serial No. 2005-33788, the contents of which are incorporated herein by reference.

### BACKGROUND OF THE INVENTION

1. Field of the Invention

The present invention relates to a telecommunication terminal, and more particularly to a telecommunication terminal having a rotatable display.

2. Description of the Related Art

As technologies related to telecommunication terminals continuously develop, current telecommunication terminals can provide not only stationary images, but also video service such as VOD (video on-demand). The display unit of conventional telecommunication terminals, however, has a vertical dimension larger than the horizontal dimension. When the display unit is supplied with a video service having a horizontal vs. vertical ratio (also known as aspect ratio) of 16:9, the screen size of the image is reduced. Therefore, a telecommunication terminal has been developed which has a rotatable display unit capable of displaying video information while being rotated in the horizontal direction, as desired. This type of telecommunication terminal will hereinafter be referred to as a telecommunication terminal having a rotatable display.

FIG. 1 shows examples of display screens of a telecommunication terminal having a rotatable display. FIG. 1A illustrates a state wherein the display has been rotated and FIG. 1B illustrates a state wherein the display has not been rotated. The user can rotate the display to any state as shown in FIG. 1 at any time for convenient use.

For use with a video service such as a VOD, the telecommunication terminal having a rotatable display can provide a wider screen for presentation of images or videos with a horizontal vs. vertical ratio where the horizontal length is larger than the vertical length. The user can accommodate video service simply by rotating the display into position to provide a large horizontal dimension for the display.

When the telecommunication terminal having a rotatable display presents images or videos on a screen having a horizontal length larger than the vertical length, as shown in FIG. 1A, it can effectively display them because the horizontal vs. vertical ratio for the image is similar to that of the screen. When displaying images or videos on a screen having a horizontal length smaller than the vertical length, however, the terminal cannot avoid reducing the images, as shown in FIG. 1B, because their horizontal vs. vertical ratio is different from that of the screen. When the display of the telecommunication terminal having a rotatable display has not been rotated, therefore, images are presented in a smaller size than when the display has been rotated.

Due to the compact size of the displays on telecommunication terminals, even when images or videos are presented in the horizontal direction on the display, they are small in size. The horizontally-displayed images or videos may even be further reduced if they are to be presented on a display which has not been rotated. As such, the user will always view reduced images or videos, except when they are displayed in the horizontal direction.

A similar problem occurs when a telecommunication terminal has a stationary display. In a telecommunication terminal having a stationary display, referring to FIG. 2, images or videos that are displayed are reduced to fit the screen size. This is because the horizontal vs. vertical ratio of the images or videos differs from that of the display screen. As a result, blank regions 2 and 4 are created on the display screen as shown in FIG. 2A. According to the prior art, information relating to photos may be displayed in the blank regions, as shown in of FIG. 2B.

In summary, conventional telecommunication terminals cannot avoid presenting images or videos on the display which are reduced in size and fail to enable users to view them in their original size.

### SUMMARY OF THE INVENTION

Accordingly, the present invention has been made to solve the above-mentioned problems occurring in the prior art. An object of the present invention is to provide a method for displaying images or videos in their original size and a telecommunication terminal using the same.

In order to accomplish this object, there is provided a telecommunication terminal having a rotatable display including a camera unit for photographing an image; a control unit for deciding the rotation angle of the display when displaying the photographed image and displaying the image on the display in a display mode set for each rotation angle; and a memory for storing the entire photographed image regardless of the rotation angle.

### BRIEF DESCRIPTION OF THE DRAWINGS

The above and other objects, features, and advantages of the present invention will be more apparent from the following detailed description taken in conjunction with the accompanying drawings, in which:

FIGS. 1A and 1B show examples of display screens of a conventional telecommunication terminal having a rotatable display;

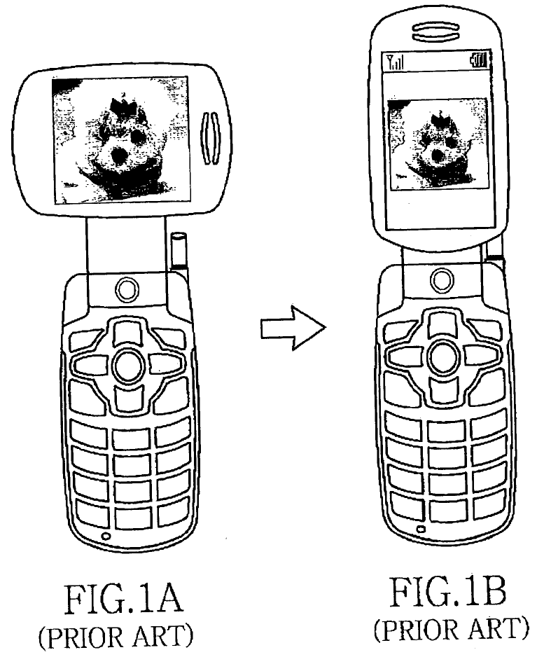

FIGS. 2A and 2B show examples of display screens of a conventional telecommunication terminal having a stationary display;

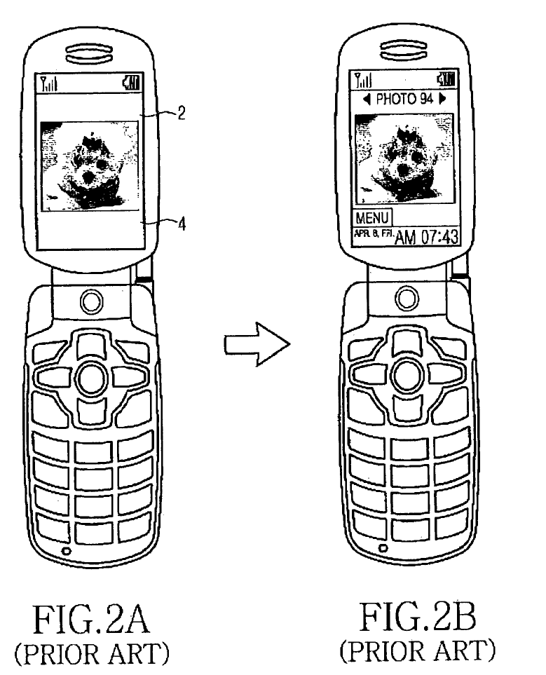

FIG. 3 is a block diagram showing the construction of a telecommunication terminal having a rotatable display according to an embodiment of the present invention;

FIG. 4 shows a flow chart for displaying images in a telecommunication terminal according to a first embodiment of the present invention;

FIGS. 5A and 5B show examples of screens when images are displayed according to a first embodiment of the present invention;

FIG. 6 shows a flow chart for displaying images in a telecommunication terminal according to a second embodiment of the present invention;

FIGS. 7A and 7B show examples of screens when images are displayed according to a second embodiment of the present invention;

FIG. 8 shows a flow chart for displaying images in a telecommunication terminal according to a third embodiment of the present invention;

FIGS. 9A and 9B show examples of screens when images are displayed according to a third embodiment of the present invention;

FIG. 10 shows a flow chart for displaying images in a telecommunication terminal according to a fourth embodiment of the present invention;

FIGS. 11A and 11B show examples of screens when images are displayed according to a fourth embodiment of the present invention;

FIG. 12 shows a flow chart for displaying images in a telecommunication terminal according to a fifth embodiment of the present invention; and

FIGS. 13A and 13B show examples of screens when images are displayed according to a fifth embodiment of the present invention.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein is omitted to avoid making the subject matter of the present invention unclear.

When images or videos are displayed in a telecommunication terminal having a rotatable display according to the present invention and while the display has not been rotated, the images and videos are not scaled and target regions of them are displayed based on the screen size of the display. When the display has been rotated, specifically, images or videos are displayed without alteration, because their horizontal vs. vertical ratio is similar to that of the display screen. The present invention can also be applied to a telecommunication terminal having a stationary display. In the case of a telecommunication terminal having a stationary display, images or videos may be displayed after rotating them based on the horizontal vs. vertical ratio of the display screen.

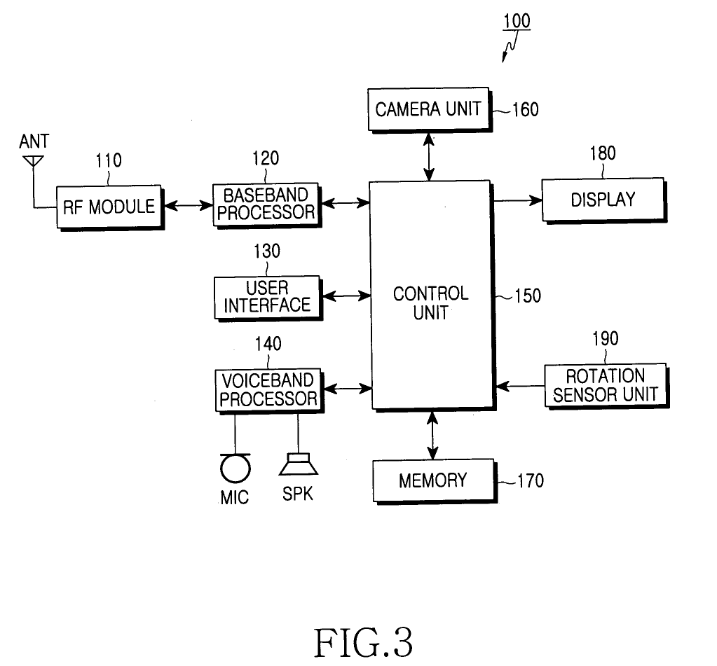

FIG. 3 is a block diagram showing the construction of a telecommunication terminal having a rotatable display according to an embodiment of the present invention. The telecommunication terminal 100 includes an RF module 110, a baseband processor 120, a user interface 130, a voiceband processor 140, a control unit 150, a camera unit 160, a memory 170, a display 180, and a rotation sensor unit 190.

The control unit 150 performs general communication functions, including voice communication and data transmission/reception, and controls other components. When photo images are displayed on the display 180 by the user or while performing a predetermined application, the control unit 150 decides the rotation angle of the display 180. Images presented on the display 180 may come from storage in the memory 170 or from photos taken with the camera unit 160. The present invention can be applied to both cases.

In the present embodiment, the state wherein the display 180 has not been rotated corresponds to a case wherein the horizontal length of the screen of the display 180 is smaller than the vertical length. The state wherein the display 180 has been rotated corresponds to a case wherein the vertical length of the screen of the display 180 is smaller than the horizontal length. It is obvious to those skilled in the art that, without departing from the scope of the present invention, the display 180 may be constructed to have rotation state and non-rotation states in the opposite manner to the present embodiment.

The rotation sensor unit 190 senses the rotation angle of the display 180 and provides the control unit 150 with the sensing result. Based on the sensing result from the rotation sensor unit 190, the control unit 150 decides whether the display 180 has been rotated, based on the rotation angle of the display 180. Depending on whether the display 180 has been rotated or not, the control unit 150 displays images or videos differently. In addition, the control unit 150 can display images or videos on the display 180 in a display mode set for each rotation angle, which will now be described in more detail.

The camera unit 160 takes photos as operated by the user and stores them in the memory 170. The images photographed by the camera unit 160 and stored in the memory 170 have a horizontal length larger than the vertical length.

Although the images which have been photographed or which are being photographed are partially displayed on the screen of the display 180 (i.e., in such a manner that their horizontal length is smaller than the vertical length), due to the smaller horizontal length of the screen than the vertical length, the images are stored in the memory 170 in such a state that their horizontal length is larger than the vertical length. In this way, the memory 170 stores the entire images which have been photographed, regardless of the current screen state or rotation angle of the display.

It is assumed in the following description of the embodiments that the camera unit 160 is designed by the manufacturer to photograph images in such a manner that their horizontal length is larger than the vertical length. However, it is obvious to those skilled in the art that the present invention can also be applied to a case wherein photo images have a horizontal length smaller than the vertical length.

The photo images photographed by the camera unit 160 have a horizontal length larger than the vertical length and their horizontal vs. vertical ratio is similar to that of the screen when the display 180 has been rotated.

When photo images are displayed on the screen of the display 180 which has not been rotated, according to the prior art, they are scaled based on the horizontal vs. vertical ratio of the screen (i.e., reduced) and then displayed. When photo images are displayed on the display 180, according to the present invention, they are displayed in the same manner as they are photographed, without being reduced or magnified, regardless of the state of the display 180. When images or videos are displayed on the display 180, specifically, the control unit 150 displays them on the display 180 as they are if the display 180 has been rotated.

When the display 180 has been rotated, as mentioned above, the vertical length of the screen of the display 180 is smaller than the horizontal length thereof (i.e., the horizontal length of the display screen is larger than or equal to the vertical length thereof) and the vertical vs. horizontal ratio of photo images is similar to that of the screen of the display 180. When photo images are displayed while the display 180 has been rotated, therefore, the control unit 150 displays them in their original size without scaling them based on the screen size. Particularly, the control unit 150 maintains the horizontal vs. vertical ratio of the images stored in the memory and display them on the display screen.

When photo images are displayed while the display 180 has not been rotated, the control unit 150 chooses and displays target regions, which have been determined based on the screen size, instead of after scaling. The size and shape of the target regions are determined in a similar manner as in the case of the screen region of a display having a larger vertical length. When images are displayed on the display 180 according to the present embodiment, therefore, it appears that photo images having a larger horizontal length are cut as much as the horizontal length of the screen of the display which has not been rotated. Particularly, parts of the photographed or stored images are deleted in such a manner that their vertical length remains unchanged and their horizontal length is reduced.

When choosing the target regions from photo images, the horizontal center of images having a larger length is regarded as the reference, unless modified by the user or by a predetermined condition. For example, both horizontal ends of stored images may be deleted and the central parts thereof are displayed on the display. The user may modify the target regions through a separate menu or during display of images.

The present embodiment of the present invention can be applied to a telecommunication terminal 100 having a stationary display and no rotation sensor unit 190. In the case of a telecommunication terminal having a stationary display, the control unit 150 may rotate images or videos based on the horizontal vs. vertical ratio of the screen of the display and display them. Particularly, the control unit 150 displays images or videos in such a direction that they have a similar horizontal vs. vertical ratio as that of the screen. The control unit 150 then can display images or videos in their original size without scaling them based on the display screen.

When a screen modification key is inputted, the control unit 150 checks the current image display state and modifies it. When images are displayed on the display screen while being scaled and reduced and a screen modification key is inputted, specifically, the control unit 150 displays them in their size as stored in the memory 170. In this case, the control unit 150 may rotate and display stored images or display parts of the stored images as target regions. When images are displayed in their size as stored and a screen modification key is inputted, the control unit 150 displays the images after scaling and reducing them.

The display 180 displays various messages under the control of the control unit 150. The display 180 may include a liquid crystal display (LCD), a transistorized thin film (TFT), and an organic electroluminescent (EL). The user interface 130 has a number of numeric and function keys and outputs key input data to the control unit 150 corresponding to keys pressed by the user.

The memory 170 connected to the control unit 150 includes a ROM and a RAM for storing a number of programs and information necessary for operational control of the telecommunication terminal. The memory 170 stores programs used by the control unit 150 to perform various operations as mentioned above, as well as photo images and videos photographed by the camera unit 160. The memory 170 also stores photo images or videos obtained via download.

Telecommunication terminals generally perform radio communication with base stations and, to this end, the RF module 110 transmits/receives RF signals to/from base stations through an antenna ANT. In particular, the RF module 110 converts received RF signals into IF (intermediate frequency) signals and outputs them to the baseband processor 120. The RF module 110 also converts IF signals inputted from the baseband processor 140 into RF signals and transmits them.

The baseband processor 120 is a baseband analog ASIC (BAA) for providing an interface between the control unit 150 and the RF module 110.

The baseband processor 120 converts digital signals of baseband applied from the control unit 150 into analog IF signals and applies them to the RF module 110. The baseband processor 120 also converts analog IF signals applied from the RF module 110 into digital signals of baseband and applies them to the control unit 150. The voiceband processor 140, which connects to the control unit 150, is connected to a microphone MIC and a speaker SPK. The voiceband processor 140 converts voiceband signals received from the microphone during call connection into data and outputs it to the control unit 150. The voiceband processor 140 also converts voiceband data input from the control unit 150 into audible sound through the speaker and outputs it. A first embodiment of the present invention will now be described with reference to FIGS. 3-5.

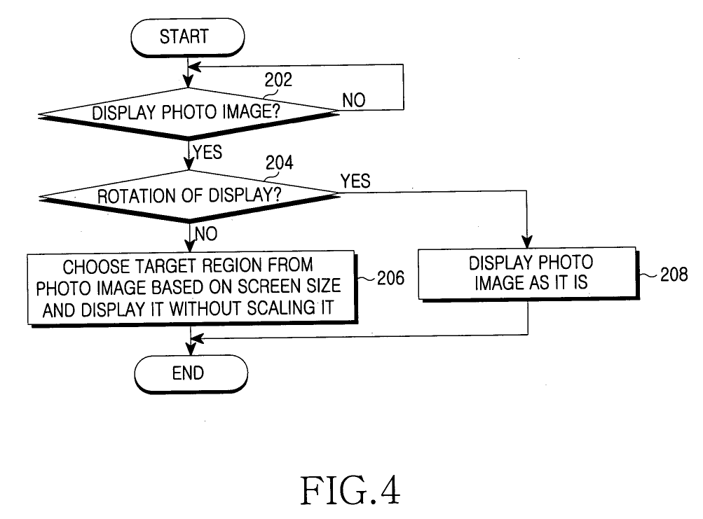

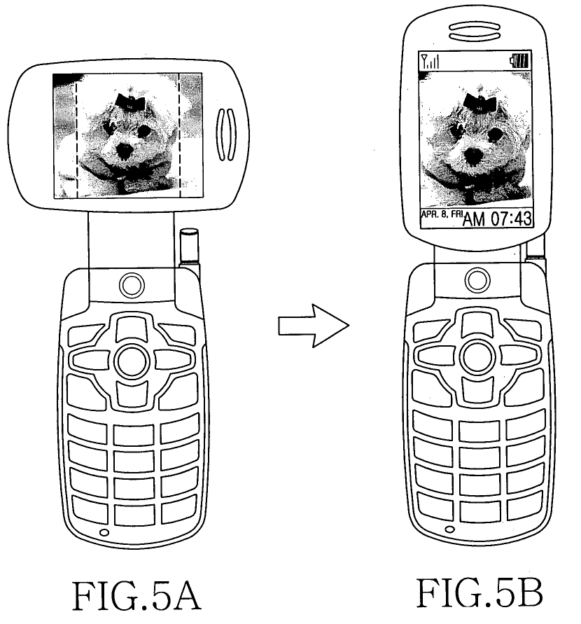

FIG. 4 shows a flow chart for displaying images in a telecommunication terminal according to a first embodiment of the present invention. FIG. 5 shows examples of screens when images are displayed according to a first embodiment of the present invention.

Referring to FIGS. 3 and 4, the control unit 150 of the telecommunication terminal decides whether photo images are requested to be displayed by the user or by a predetermined application in step 202. As mentioned above, the images displayed on the display 180 come from either storage in the memory 170 or from photos being taken with the camera unit 160.

When photo images are requested to be displayed by the user or by a predetermined application, the control unit 150 determines whether the display has been rotated or not by deciding the rotating angle of the display in step 204.

When the display 180 has been rotated, the control unit 150 proceeds to step 208 and displays photo images on the display 180 as they are. When the display 180 has been rotated, as mentioned above, the horizontal length of the display screen is larger than or equal to the vertical length thereof and the vertical vs. horizontal ratio of the photo images becomes similar to that of the screen of the display 180. With the display 180 rotated, therefore, the control unit 150 displays photo images in their original size without scaling based on the screen size. The horizontal vs. vertical ratio and size of the images are similar to those of the screen of the display 180, as shown in of FIG. SA, so that the images can be displayed without modification.

When the display 180 has not been rotated, i.e., when the horizontal length of the display screen is smaller than the vertical length thereof, the control unit 150 proceeds to step 206 and chooses and displays target regions which have been determined from images or videos based on the screen size, without scaling based on the screen size. When the horizontal vs. vertical ratio of the display screen is different from that of images to be displayed, therefore, the control unit 150 only partially displays the images.

For example, a target region is chosen from a photo image based on the horizontal length of the display 180, as indicated by dotted lines in FIG. 5A, and is displayed as shown in FIG. 5B. When choosing target regions from photo images, as mentioned above, the horizontal center of images having a larger length is regarded as the reference, unless modified by the user or by a predetermined condition.

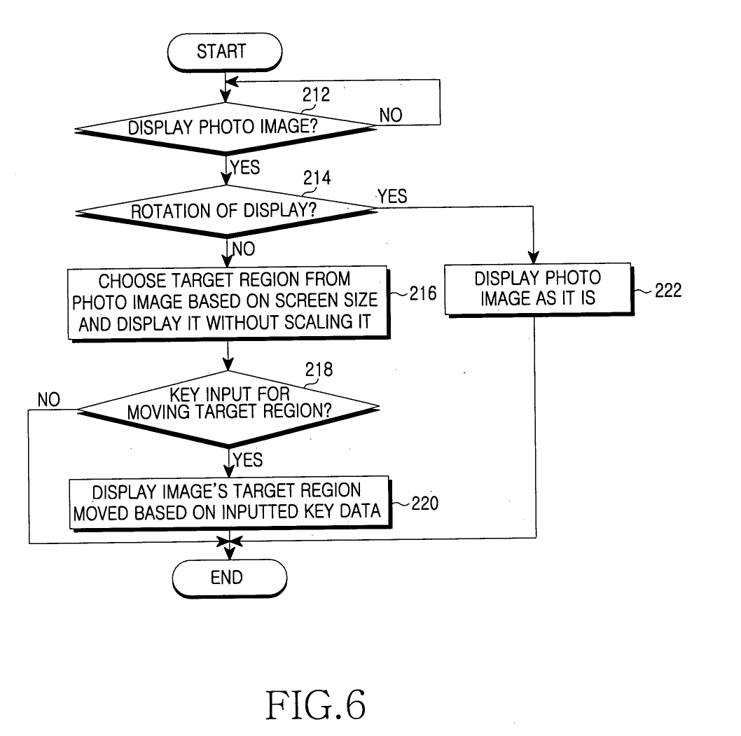

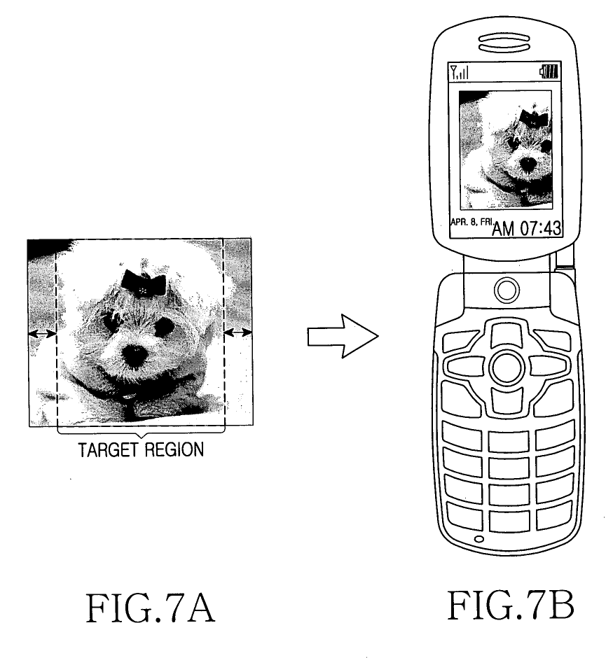

A second embodiment of the present invention will now be described with reference to FIGS. 6 and 7. FIG. 6 shows a flow chart for displaying images in a telecommunication terminal according to a second embodiment of the present invention. FIG. 7 shows examples of screens when images are displayed according to a second embodiment of the present invention. Steps 212 to 216 and 222 in the flow chart of FIG. 6 are similar to steps 202 to 206 and 208 of FIG. 4 and repeated description thereof will be omitted for clarity.

When displaying photo images in steps 212 to 216 while the display 180 has not been rotated, referring to FIGS. 6 and 7, the control unit 150 of the telecommunication terminal chooses and displays target regions which have been determined from images or videos based on the screen size, without scaling based on the screen size. The control unit 150 then decides whether there is key input for moving the target regions or not in step 218. When desired regions are not displayed, the user can move the target regions as desired with scroll or arrow keys, which may be provided on the user interface 130. When the user enters key input for moving the target regions, the control unit 150 proceeds to step 220 and displays images in the target regions which have been moved based on the key input. Referring to FIG. 7A, for example, a target region as indicated by dotted lines can be moved as indicated by arrows, based on the key input from the user. The target region of the image is then moved and displayed as shown in FIG. 7B.

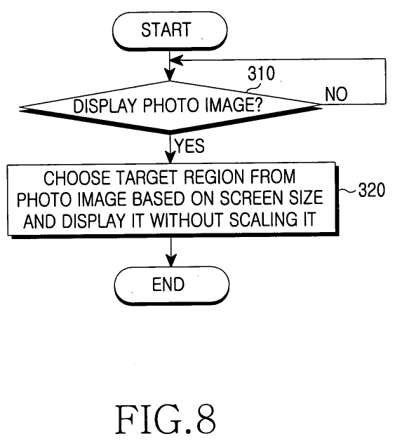

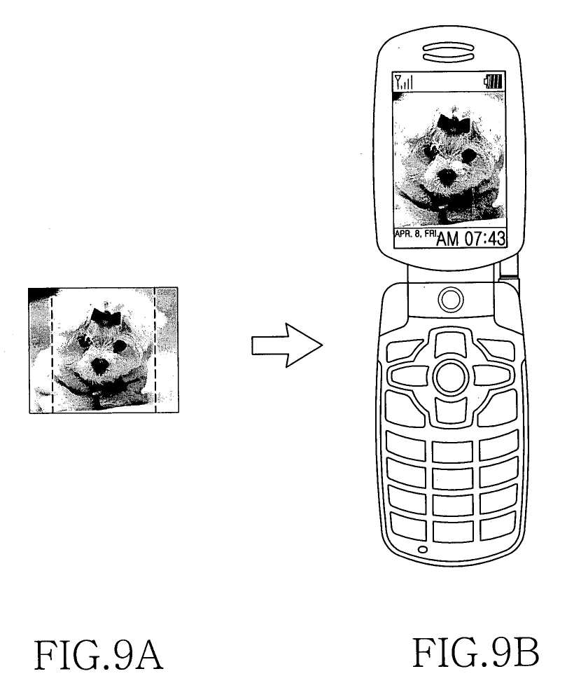

Application of the present invention to a telecommunication terminal having a stationary display will now be described with reference to FIGS. 8 and 9.

FIG. 8 shows a flow chart for displaying images in a telecommunication terminal according to a third embodiment of the present invention. FIG. 9 shows examples of screens when images are displayed according to a third embodiment of the present invention.

Referring to FIGS. 8 and 9, the control unit 150 of the telecommunication terminal decides whether photo images are requested to be displayed by the user or by a predetermined application in step 310. When photo images are requested to be displayed by the user or by a predetermined application, the control unit 150 proceeds to step 320 and chooses and displays target regions which have been determined from images or videos based on the screen size, without scaling based on the screen size. For example, a target region is chosen from a photo image based on the horizontal length of the display 180, as indicated by dotted lines in FIG. 9A, and is displayed as shown in FIG. 9B. When choosing target regions from photo images, as mentioned above, the horizontal center of images having a larger length is regarded as the reference, unless modified by the user or by a predetermined condition.

If the horizontal vs. vertical ratio of photo images is similar to that of the screen of the display 180 of the telecommunication terminal having a stationary display, the control unit 150 displays photo images as they are without performing the flow chart shown in FIG. 8.

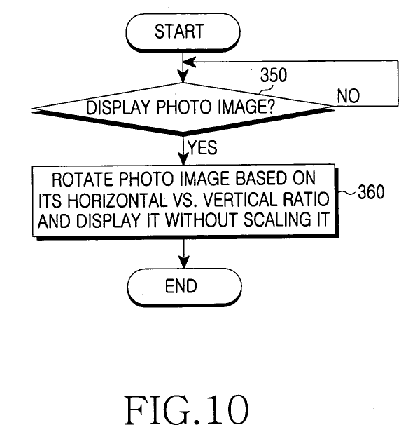

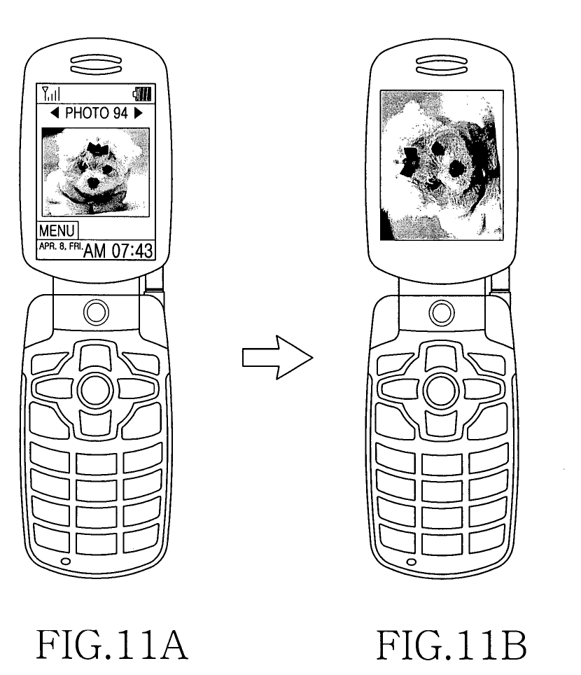

An example of displaying images in a telecommunication terminal having a stationary display according to a fourth embodiment of the present invention will now be described with reference to FIGS. 10 and 11. FIG. 10 shows a flow chart for displaying images in a telecommunication terminal according to a fourth embodiment of the present invention. FIG. 11 shows examples of screens when images are displayed according to a fourth embodiment of the present invention.

Referring to FIGS. 10 and 11, the control unit 150 of the telecommunication terminal decides whether photo images are requested to be displayed by the user or by a predetermined application in step 350. When photo images are requested to be displayed by the user or by a predetermined application, the control unit 150 proceeds to step 360 and displays photo images after rotating them, e.g., 90°, based on the horizontal vs. vertical ratio of the photo images, without scaling based on the screen size. In particular, the control unit 150 compares the horizontal vs. vertical ratio of the screen of the display 180 with that of photo images to be display and, if the ratios are similar to each other, displays the photo images on the display 180 as they are.

When a photo image having a horizontal length larger than the vertical length is displayed on a display screen having a horizontal length smaller than the vertical length as shown in FIG. 11A, for example, the control unit 150 rotates the photo image 90° and displays it as shown in FIG. 11B. It is obvious to those skilled in the art that the rotation angle of images is determined in such a manner that the entire images are displayed on the display screen without being reduced or magnified and is not limited to 90° but may vary depending on applications or whether original images have been rotated or not.

If the horizontal vs. vertical ratio of photo images is similar to that of the screen of the display 180 of the telecommunication terminal having a stationary display, as in the third embodiment of the present invention, the control unit 150 displays photo images as they are without performing the flow chart shown in FIG. 10.

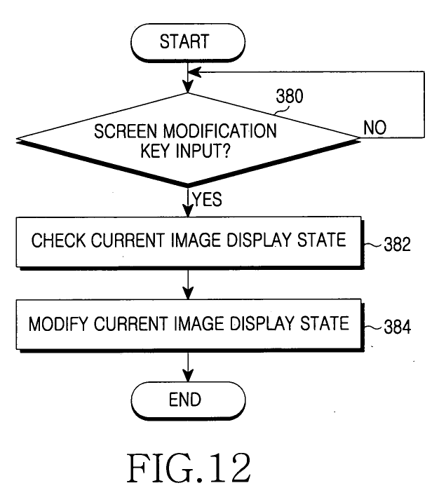

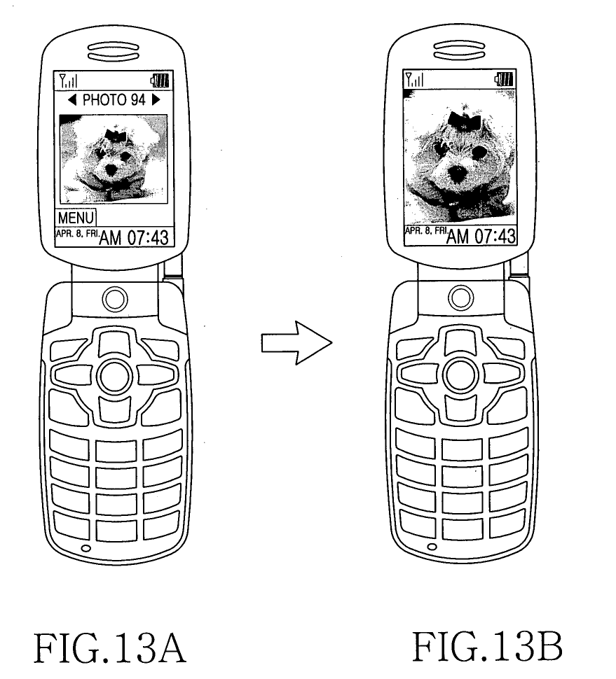

An example of displaying images in a telecommunication terminal having a stationary display according to a fifth embodiment of the present invention will now be described with reference to FIGS. 12 and 13. FIG. 12 shows a flow chart for displaying images in a telecommunication terminal according to a fifth embodiment of the present invention. FIG. 13 shows examples of screens when images are displayed according to a fifth embodiment of the present invention.

The control unit 150 decides in step 380 whether a screen modification key is input. The screen modification key enables the user to modify the size or display region of images displayed on the screen.

When the screen modification key is input by the user, the control unit 150 proceeds to step 382 and checks the current image display state. The control unit 150 then proceeds to step 384 and modifies the image display state. Particularly, the control unit 150 causes current images to be displayed in a different manner. When images are displayed on the display screen while being scaled and reduced and a screen modification key is inputted, as mentioned above, the control unit 150 displays them in their size as stored in the memory 170. In this case, the control unit 150 may rotate and display stored images or display parts of the stored images as target regions. The former corresponds to a case wherein the screen shown in FIG. 11A is modified into the screen shown in FIG. 11B and the latter corresponds to a case wherein the screen shown in FIG. 13A is modified into the screen shown of FIG. 13B.

When images are displayed on the display screen as stored and the screen modification key is input, the control unit 150 displays images after reducing by scaling. It is obvious to those skilled in the art that such screen modification can be performed by a predetermined menu.

As mentioned above, the present invention properly displays photo images or videos on the display based on their horizontal vs. vertical ratio so that the user can view them in their original size. The present invention can also display photo images on the display screen in the most effective manner.

While the invention has been shown and described with reference to certain preferred embodiments thereof, it will be understood by those skilled in the art that various changes in form and details may be made therein without departing from the spirit and scope of the invention as defined by the appended claims. It is obvious to those skilled in the art that, although previous embodiments of the present invention have been only described with reference to a case wherein, when the display of the telecommunication terminal having a rotatable display has been rotated, the horizontal length is larger than the vertical length, the present invention can also be applied to a case wherein, when the display has been rotated, the horizontal length is smaller than the vertical length.

It is also obvious to those skilled in the art that, although previous embodiments of the present invention have been only described with reference to a case wherein the camera unit is designed by the manufacturer to photograph images in such a manner that their horizontal length is larger than the vertical length or images have a horizontal length larger than the vertical length, the present invention can also be applied to a case wherein photo images have a horizontal size smaller than the vertical size.

What is claimed is:

1. A telecommunication terminal having a rotatable display comprising:
a camera unit for photographing an image;
a control unit for determining the rotation angle of the display when displaying the photographed image and displaying the image on the display in a display mode set for each rotation angle; and
a memory for storing the entire photographed image regardless of the rotation angle.

2. The telecommunication terminal as claimed in claim 1, wherein the control unit displays the entire photographed image on the screen of the display when a horizontal length of the screen is greater than or equal to a vertical length thereof after determining the rotation angle of the display.

3. The telecommunication terminal as claimed in claim 1, wherein the control unit displays a target region of the photographed image, which has been set within the image, when a horizontal length of the screen is less than a vertical length thereof after determining the rotation angle of the display.

4. The telecommunication terminal as claimed in claim 3, wherein, when a key input for moving the target region exists, the control unit displays the target region of the image which has been moved according to input key data.

5. The telecommunication terminal as claimed in claim 3, wherein the target region is chosen by one of a key input from a user and setting of an application.

6. The telecommunication terminal as claimed in claim 1, wherein the control unit displays the image stored in the memory on a screen of the display while maintaining a horizontal vs. vertical ratio of the image when a horizontal length of the screen is greater than or equal to a vertical length thereof after determining the rotation angle of the display.

7. The telecommunication terminal as claimed in claim 1, wherein the control unit displays the photographed image after deleting a part thereof in such a manner that a vertical length thereof remains unchanged and a horizontal length thereof is reduced when a horizontal length of the screen is less than a vertical length thereof after determining the rotation angle of the display.

8. The telecommunication terminal as claimed in claim 7, wherein both horizontal ends of the photographed image are deleted and a central part thereof is displayed.

9. A telecommunication terminal having a display comprising:
a memory for storing an image; and
a control unit for displaying a target region of the image stored in the memory, which has been set within the image, on the display in a preset display mode or displaying the stored image on the display after reducing it.

10. A telecommunication terminal having a display comprising:
a camera unit for photographing an image;
a control unit for displaying a target region of the photographed image, which has been set within the image, on the display in a preset display mode; and
a memory for storing the entire photographed image regardless of the setting of the display mode.

11. The telecommunication terminal as claimed in claim 10, wherein the control unit displays the photographed image on the display after reducing it while maintaining a horizontal vs. vertical ratio thereof according to the preset display mode.

12. The telecommunication terminal as claimed in claim 10, wherein the setting of the display mode is performed by a key input from a user or by modification of an application setting.

13. The telecommunication terminal as claimed in claim 10, wherein, when a key input for moving the target region of the image exists, the target region according to input key data is displayed.

14. The telecommunication terminal as claimed in claim 10, wherein the target region is chosen by any of a key input from a user and setting of an application.

15. A telecommunication terminal having a display comprising:
a camera unit for photographing an image;
a control unit for displaying the photographed image on the display after deleting a part of the image in such a manner that a vertical length thereof remains unchanged and a horizontal length thereof is reduced according to a preset display mode; and
a memory for storing the entire photographed image regardless of the setting of the display mode.

16. The telecommunication terminal as claimed in claim 15, wherein the control unit is adapted to delete both horizontal ends of the photographed image and display a central part thereof according to the preset display mode.

17. The telecommunication terminal as claimed in claim 15, wherein the control unit displays the photographed image on the display after reducing it, while maintaining a horizontal vs. vertical ratio thereof according to the preset display mode.

18. A telecommunication terminal having a memory comprising:
a display for displaying an image stored in the memory; and
a control unit for rotating the stored image 90° and displaying the entire image on the display, or for reducing the stored image and displaying it on the display according to a preset display mode.

19. The telecommunication terminal as claimed in claim 18, wherein the setting of the display mode is performed by a key input from a user or by modification of an application setting.

20. A telecommunication terminal having a memory comprising:
a display for displaying an image stored in the memory; and
a control unit for rotating the stored image 90° and displaying the entire image on the display, or for displaying a target region of the image, which has been set within the image, on the display according to a preset display mode.

21. The telecommunication terminal as claimed in claim 20, wherein the setting of the display mode is performed by a key input from a user or by modification of an application setting.

22. The telecommunication terminal as claimed in claim 20, wherein, when a key input for moving the target region of the image exists, the target region according to input key data is displayed.

23. The telecommunication terminal as claimed in claim 20, wherein the target region is chosen by one of a key input from a user and setting of an application.

24. A method for displaying an image in a telecommunication terminal having a camera unit for photographing an image and a rotatable display, the method comprising the steps of:
determining a rotation angle of the display when displaying an image photographed by the camera unit; and
displaying the image on the display in a display mode set for each rotation angle.

25. A method for displaying an image in a telecommunication terminal having a display and a memory for storing an image, the method comprising the steps of:
determining a preset display mode when displaying an image; and
displaying any one of a target region of an image stored in the memory, which has been set within the image, and the stored image, which has been reduced, according to the preset display mode.

26. A method for displaying an image in a telecommunication terminal having a display and a camera for photographing an image, the method comprising the steps of:
determining a preset display mode when displaying an image; and
displaying one of a target region of a photographed image, which has been set within the image, and the photographed image, which has been reduced, according to the preset display mode.

27. A method for displaying an image in a telecommunication terminal having a display and a memory for storing an image, the method comprising the steps of:
determining a preset display mode when displaying an image; and
displaying one of an image stored in the memory, which has been rotated 90°, and the stored image, which has been reduced, according to the preset display mode.
